(19) United States
(12) Patent Application Publication
(10) Pub. No.: US 2024/0322581 A1
(43) Pub. Date: Sep. 26, 2024

(54) INFORMATION PROCESSING APPARATUS, INFORMATION PROCESSING METHOD, NON-TRANSITORY COMPUTER READABLE MEDIUM, AND INFORMATION PROCESSING SYSTEM

(71) Applicants: KABUSHIKI KAISHA TOSHIBA, Tokyo (JP); TOSHIBA ENERGY SYSTEMS & SOLUTIONS CORPORATION, Kawasaki-shi Kanagawa (JP)

(72) Inventors: Sunao YOTSUTSUJI, Kawasaki Kanagawa (JP); Tomoshi OTSUKI, Kawasaki Kanagawa (JP); Ryusei SHINGAKI, Setagaya Tokyo (JP); Chihiro KASAI, Kawasaki Kanagawa (JP)

(73) Assignees: KABUSHIKI KAISHA TOSHIBA, Tokyo (JP); TOSHIBA ENERGY SYSTEMS & SOLUTIONS CORPORATION, Kawasaki-shi Kanagawa (JP)

(21) Appl. No.: 18/458,417

(22) Filed: Aug. 30, 2023

(30) Foreign Application Priority Data
Mar. 20, 2023 (JP) 2023-044720

(51) Int. Cl. H02J 7/00; G06Q 30/0273

(52) U.S. Cl. CPC H02J 7/0048; G06Q 30/0275

(57) ABSTRACT

According to one embodiment, an information processing apparatus includes a processing circuitry which acquires information of a first connection time period during which a mobile object is connected to a charge connector among a first period, the charge connector configured to become capable of control of charge and discharge and measurement of a remaining charge amount of a storage battery included in the mobile object when the mobile object is connected to the charge connector, and acquires information on a remaining charge amount of the storage battery measured during the first connection time period, and which estimates a second connection time period during which the mobile object is connected to the charge connector among the second period and a remaining charge amount of the storage battery during the second connection time period, based on the information of the first connection time period and the information on the remaining charge amount.

### CROSS REFERENCE TO RELATED APPLICATIONS

This application is based upon and claims the benefit of priority from the prior Japanese Patent Application No. 2023-044720, filed on Mar. 20, 2023, the entire contents of which are incorporated herein by reference.

### FIELD

Embodiments described herein relate to an information processing apparatus, an information processing method, a non-transitory computer readable medium, and an information processing system.

### BACKGROUND

In electric power markets including supply-demand adjustment markets, in order to use storage batteries included in mobile objects such as electric vehicles (EVs) owned by a plurality of consumers as power resources to be bid on in a market, a future remaining charge of storage battery of the storage battery included in each mobile object must be accurately estimated.

Furthermore, even in order to use the storage battery included in a mobile object of each consumer as a power resource with respect to a demand response (DR), a future remaining charge amount of the storage battery must be accurately estimated.

In addition, when a user leaves a consumer's residence using a mobile object or when the user has forgotten to connect the mobile object to a charge connector, a storage battery of the mobile object cannot be used as a power resource. Therefore, in addition to the remaining charge amount of the storage battery, a period of time during which the mobile object is connected to the charge connector must also be accurately estimated.

### BRIEF DESCRIPTION OF THE DRAWINGS

FIG. 1 is a block diagram showing an outline of an overall system configuration according to a basic embodiment of the present invention;

FIG. 2 is a block diagram showing a configuration of an information estimation apparatus according to a first embodiment of the present invention;

FIG. 3 is a flow chart schematically showing a procedure of estimating a battery remaining charge amount and a non-connection interval in the information estimation apparatus according to the first embodiment of the present invention;

FIG. 4 is a diagram showing an example of battery remaining charge amount information and missing interval information of a battery remaining charge amount that are used in the information estimation apparatus according to the first embodiment of the present invention;

FIG. 5 is a flow chart schematically showing an example of a procedure of specifying a non-connection interval in the information estimation apparatus according to the first embodiment of the present invention;

FIG. 6 is a diagram showing an example of date-related information and non-connection interval-related information that are used in the information estimation apparatus according to the first embodiment of the present invention and an example of non-connection interval information of a battery remaining charge amount that is generated in the information estimation apparatus;

FIG. 7 is a flow chart schematically showing an example of a procedure of estimating a non-connection interval in the information estimation apparatus according to the first embodiment of the present invention;

FIG. 8 is a flow chart schematically showing an example of a procedure of estimating a battery remaining charge amount in the information estimation apparatus according to the first embodiment of the present invention;

FIG. 9 is a diagram showing an example of estimated non-connection interval information and estimated battery remaining charge amount information that are outputted in the information estimation apparatus according to the first embodiment of the present invention;

FIG. 10 is a diagram showing, in a table format, an example of estimated non-connection interval information and estimated battery remaining charge amount information that are outputted in the information estimation apparatus according to the first embodiment of the present invention;

FIG. 11 is a block diagram showing a configuration of a DR-enabled amount calculation apparatus according to a second embodiment of the present invention;

FIG. 12 is a diagram showing an example of estimated non-connection interval information and estimated battery remaining charge amount information that are used in the DR-enabled amount calculation apparatus according to the second embodiment of the present invention;

FIG. 13 is a diagram showing an example of DR-related information that is used in an information estimation apparatus according to the second embodiment of the present invention;

FIG. 14 is a diagram showing an example of storage battery specification information that is used in the information estimation apparatus according to the second embodiment of the present invention;

FIG. 15 is a flow chart schematically showing an example of a procedure of calculating a DR-enabled amount in the information estimation apparatus according to the second embodiment of the present invention;

FIG. 16 is a diagram showing an example of a total DR-enabled amount of all consumers that is outputted in the information estimation apparatus according to the second embodiment of the present invention;

FIG. 17 is a diagram showing an example of a total DR-enabled amount of all consumers in a case of upward DR that is outputted in the information estimation apparatus according to the second embodiment of the present invention;

FIG. 18 is a block diagram showing a configuration of a required charging amount calculation apparatus according to a third embodiment of the present invention;

FIG. 19 is a table showing an example of mobile object use-related information and storage battery specification information that are used in an information estimation apparatus according to the third embodiment of the present invention and an example of required charging amount information that is generated in the information estimation apparatus;

FIG. 20 is a flow chart schematically showing an example of a procedure of calculating a required charging amount in the information estimation apparatus according to the third embodiment of the present invention; and

FIG. 21 is a diagram showing a hardware configuration of an information processing apparatus according to an embodiment of the present invention.

### DETAILED DESCRIPTION

According to one embodiment, an information processing apparatus, includes: a processing circuitry configured to acquire information of a first connection time period during which a mobile object is connected to a charge connector among a first period, the charge connector configured to become capable of control of charge and discharge and measurement of a remaining charge amount of a storage battery included in the mobile object when the mobile object is connected to the charge connector, and information on a remaining charge amount of the storage battery measured during the first connection time period, and estimate a second connection time period during which the mobile object is connected to the charge connector among the second period and a remaining charge amount of the storage battery during the second connection time period, based on the information of the first connection time period and the information on the remaining charge amount of the storage battery.

Hereinafter, embodiments of the present invention will be described with reference to the drawings.

### (Overall Configuration)

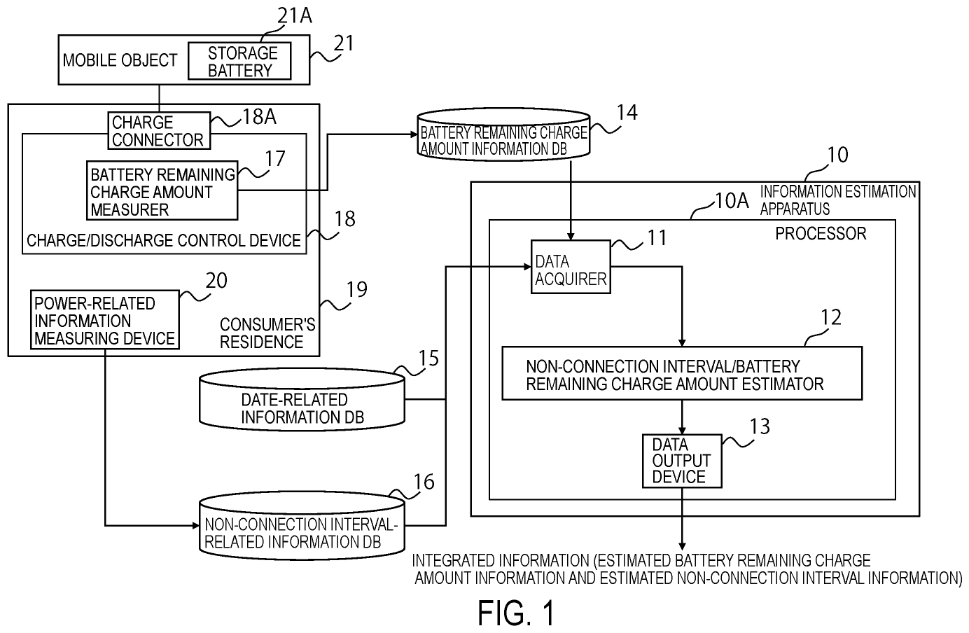

FIG. 1 is a block diagram showing an outline of an overall system configuration according to a basic embodiment of the present invention. The present system roughly includes a mobile object 21 which is provided in a consumer's residence 19 and which includes a storage battery 21A, a charge/discharge control device 18 provided in the consumer's residence 19, a battery remaining charge amount information DB 14, a date-related information DB 15, a non-connection interval-related information DB 16, and an information estimation apparatus 10 that is an information processing apparatus. As the consumer's residence 19, a residential house (low-voltage consumer) is mainly assumed. Alternatively, the consumer's residence 19 may be a high-voltage consumer or a special high-voltage consumer such as an office building, a commercial building, a public facility, or a factory. In addition, as the mobile object 21 including a storage battery, an electric vehicle (EV) is mainly assumed. Alternatively, the mobile object 21 may be an electric mobile object such as a plug-in hybrid vehicle or a drone or a non-electric mobile object. Examples of a storage battery include a lead storage battery, a nickel-cadmium battery, a nickel-hydrogen battery, a lithium ion battery, an all-solid-state battery, and a fuel cell. The storage battery can be repetitively charged and discharged and is also referred to as a secondary battery.

In a case where the mobile object 21 is an EV, the EV is present outside of the consumer's residence 19 when a user uses the EV to go out and the EV is placed inside the consumer's residence 19 once the user comes home. By connecting the mobile object 21 to a charge connector 18A of the charge/discharge control device 18, the storage battery 21A can be charged or discharged (charged and discharged) by the charge/discharge control device 18. In other words, while the storage battery 21A of the mobile object 21 included in the consumer's residence 19 is being connected to the charge connector 18A, charge and discharge of the storage battery 21A can be performed based on control by the charge/discharge control device 18. The charge and discharge may possibly cause a remaining charge amount of the storage battery 21A to vary (the remaining charge amount of the storage battery may be simply called a storage amount etc.). In addition, when the mobile object 21 is being connected to the charge connector 18A, a battery remaining charge amount can be measured by a battery remaining charge amount measurer 17 of the charge/discharge control device 18. There may be cases where the user forgets to connect to the battery remaining charge amount measurer 17. Even in this case, the storage battery 21A cannot be charged and discharged and a battery remaining charge amount cannot be measured even when the mobile object 21 is inside the consumer's residence 19.

More specifically, the charge/discharge control device 18 includes the charge connector 18A to which the mobile object 21 is connected and the battery remaining charge amount measurer 17. The charge connector 18A may be an outlet to be connected to, for example, a plug of a charge cable included in the mobile object 21. Besides a wired connection, the charge connector 18A may be connected to the mobile object 21 in a wireless manner (for example, by magnetic coupling). In this case, the charge/discharge control device 18 may control charge and discharge of the mobile object 21 using wireless power transmission. In a state where the mobile object 21 is connected to the charge connector 18A, the battery remaining charge amount measurer 17 measures the remaining charge amount of the storage battery 21A at times of day at regular time intervals and acquires battery remaining charge amount information. The battery remaining charge amount can only be acquired during a time period (connection time period) in which the mobile object 21 is connected. A time period other than the connection time period corresponds to a time period (a non-connection time period or a missing interval) in which the mobile object 21 is not connected. The battery remaining charge amount measurer 17 also acquires information (missing interval information or non-connection time period information) of a time period during which the mobile object 21 is not connected to the charge connector 18A and a battery remaining charge amount cannot be measured. The battery remaining charge amount measurer 17 cannot measure the battery remaining charge amount of the mobile object 21 and charge or discharge the mobile object 21 during a time slot in which the mobile object 21 is absent from the consumer's residence 19 or a time slot in which the mobile object 21 is not connected to the charge connector 18A despite being present at the consumer's residence 19. Such missing interval information (information of a non-connection time period) of a battery remaining charge amount is acquired together with battery remaining charge amount information including both information of a measured time slot (first connection time period) and information of a battery remaining charge amount during the time slot.

The battery remaining charge amount information DB 14 stores or accumulates battery remaining charge amount information and missing interval information acquired by the charge/discharge control device 18. The battery remaining charge amount information DB 14 stores battery remaining charge amount information including both information of the first connection time period during which the mobile object 21 is connected to the charge connector 18A among a first period and information of a remaining charge amount of the storage battery 21A measured during the first connection time period and information (missing interval information) of a first non-connection time period during which the mobile object 21 is not connected to the charge connector 18A and battery remaining charge amount is not measured among the first period. For example, the first period is a period preceding the present.

The date-related information DB 15 accumulates date-related information that represents an attribute related to a date. The attribute may be a day of week, a classification such as a weekday, a public holiday, or a holiday, a presence or absence of an occurrence of a specific event, or weather (weather conditions). The date-related information DB 15 is used to specify an attribute of a date on which battery remaining charge amount information has been measured.

A power-related information measuring device 20 measures an operating state of a device inside the consumer's residence 19 and generates power-related information. For example, a time of day of start of use and a time of day of end of use (or an operation duration) of a device such as various electrical appliances in the consumer's residence 19 are measured. The measurement may be performed based on a fluctuation in power consumption of the device or performed based on ON/OFF signals of the device. For example, at a time of day or during a time period in which the device is operating, the power-related information may be used to determine that the mobile object 21 is present at the consumer's residence 19. In addition, for example, when the mobile object 21 is not connected to a charge connector at a time of day or during a time period in which the device is operating, the power-related information may be used to determine that the user has forgotten to connect the mobile object 21 to the charge connector.

The non-connection interval-related information DB 16 stores or accumulates, as non-connection interval-related information, information related to a condition (determination condition) for specifying an absence time period (absence interval) during which the mobile object 21 is not present at the consumer's residence 19 among the non-connection time period from the missing interval information described earlier. While a condition of specifying an absence interval among the non-connection time period is stored in the present embodiment, a condition may be stored for each of a plurality of factors of non-connection. For example, a first factor among the factors may be the mobile object 21 not being present at the consumer's residence 19 (the mobile object 21 being present at a first location where the mobile object 21 cannot be connected) and not being connected to the charge connector 18A (absence) and a second factor among the factors may be the mobile object 21 being present at the consumer's residence 19 (the mobile object 21 being present at a second location where the mobile object 21 can be connected) but not being connected to the charge connector 18A (forgotten connection). In the present embodiment, the latter case being the second factor will be mainly explained.

The non-connection interval-related information may also be considered, for example, information that defines a condition of extracting a non-connection interval (in this case, an absence interval) from missing interval information. The non-connection interval-related information may be directly inputted by the user from an external apparatus in the consumer's residence 19 or power-related information measured by the power-related information measuring device 20 may be inputted as non-connection interval-related information. Otherwise, power-related information measured by the charge/discharge control device 18 or the like may be inputted as non-connection interval-related information.

Supposing that only the first factor and the second factor described above exist as factors, missing intervals (non-connection time periods) indicated by missing interval information can include one of or both of a first time period (absence interval) in which the mobile object 21 is present at a first location where the mobile object 21 cannot be connected to the charge connector 18A and the mobile object 21 is not connected to the charge connector 18A and a second time period (presence interval) in which the mobile object 21 is present at a second location where the mobile object 21 can be connected to the charge connector 18A and not being connected to the charge connector 18A (forgotten connection). There may be factors other than the first factor and the second factor described above.

As a processor 10A corresponding to a processing circuitry that performs processing of the present embodiment, the information estimation apparatus 10 includes a data acquirer 11 that acquires information from the DBs 14, 15, and 16, a non-connection interval/battery remaining charge amount estimator 12 that estimates a future non-connection interval (non-connection time period) and a future battery remaining charge amount based on the information and generates estimated non-connection interval information and estimated battery remaining charge amount information, and a data output device 13 that outputs the estimated non-connection interval information and the estimated battery remaining charge amount information. The estimated battery remaining charge amount information includes a time period (second connection time period) during which the mobile object 21 is connected to the charge connector and a battery remaining charge amount at each time of day in the connection time period. In the present example, as described above, a time period (absence interval) during which the mobile object 21 is not present at the consumer's residence 19 is assumed as the estimated non-connection interval. The estimated battery remaining charge amount information corresponds to the second period in a period that is an object of estimating a non-connection interval (non-connection time period) and a battery remaining charge amount. While the second period is assumed to be a period following the present, alternatively, the second period may be a period preceding the present. At least a part of or all of the second period may differ from the first period during which information of the battery remaining charge amount information DB14 is accumulated.

Information outputted by the data output device 13 may be displayed on, for example, a display apparatus used by a user in the consumer's residence 19. The displayed data may include a time period (second connection time period) during which the mobile object 21 is connected to the charge connector in the future and a battery remaining charge amount according to the connection time period and may also include a time period (non-connection time period) during which the mobile object 21 is not connected to the charge connector. Accordingly, a connection state of the mobile object 21 to the charge connector 18A may be made manageable in advance. Alternatively, the outputted information may be transmitted to a predetermined server that manages usage states of the storage battery 21A and connection states of the mobile object 21 with respect to a plurality of consumer residences in a concentrated manner. Besides the estimated non-connection interval information and the estimated battery remaining charge amount information, the data output device 13 may output information on past non-connection intervals, past battery remaining charge amount information, and the like and display these pieces of information at the same time.

Note that in the information estimation apparatus 10, estimating a future non-connection interval and a future battery remaining charge amount as described above does not require preparing plan information of charge/discharge control of the storage battery 21A in the consumer's residence 19 in advance. In addition, regarding an estimation method of a battery remaining charge amount and a non-connection interval, all of the pieces of information that can be acquired from the DBs need not be used and a method of outputting a past measurement result as-is as an estimation or an estimation method based on a statistical model or machine learning may be adopted. A battery remaining charge amount and a non-connection interval may be estimated using the same estimation method or different estimation methods. The non-connection interval-related information in the DB 16 need not necessarily be used and a missing interval indicated by missing interval information may be adopted as-is as a non-connection interval (in other words, a distinction need not be made with respect to factors of non-connection such as whether the mobile object 21 is absent from or present at the consumer's residence 19). Alternatively, a battery remaining charge amount and a non-connection interval may be estimated without using any piece of missing interval information and absence interval-related information. In addition, a non-connection interval need not necessarily be estimated and being able to estimate at least a connection time period (second connection time period) during which the storage battery 21A is connected and a remaining charge amount of the storage battery 21A during the connection time period may suffice.

Hereinafter, the present embodiment will be described in greater detail.

### First Embodiment

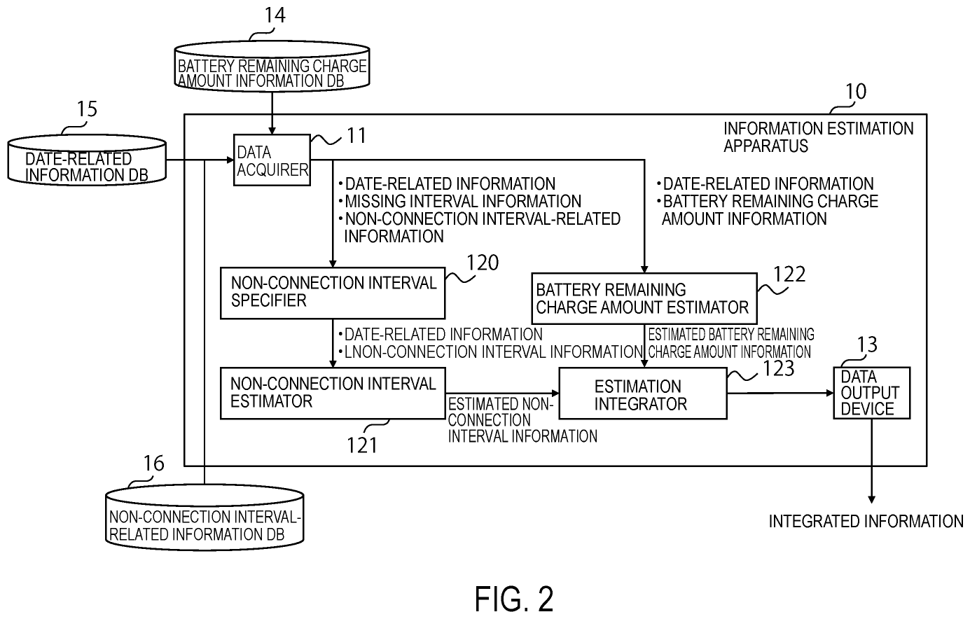

FIG. 2 is a block diagram showing a configuration of the information estimation apparatus 10 according to a first embodiment of the present invention. The information estimation apparatus 10 according to the first embodiment includes the data acquirer 11, a non-connection interval specifier 120, a non-connection interval estimator 121, a battery remaining charge amount estimator 122, an estimation integrator 123, and the data output device 13. The data acquirer 11, the non-connection interval specifier 120, the non-connection interval estimator 121, the battery remaining charge amount estimator 122, the estimation integrator 123, and the data output device 13 correspond to the processor 10A shown in FIG. 1. Elements that are the same as or corresponding to elements in FIG. 1 will be denoted by same reference signs and detailed descriptions thereof will be omitted when appropriate.

The data acquirer 11 respectively acquires information from the DB 14, DB 15, and DB 16 in a similar manner to FIG. 1.

The non-connection interval specifier 120 specifies a non-connection interval that is a non-connection time period (second non-connection time period) during which the mobile object 21 is not connected based on missing interval information and non-connection interval-related information among the information acquired by the data 11 acquirer and generates non-connection interval information representing the non-connection interval. In the present example, the non-connection interval is an absence interval during which the mobile object 21 is not present at the consumer's residence 19. The non-connection interval information is outputted to the non-connection interval estimator 121 together with date-related information.

Based on the date-related information and the non-connection interval information inputted from the non-connection interval specifier 120, the non-connection interval estimator 121 estimates non-connection interval in the future and generates estimated non-connection interval information, and outputs the estimated non-connection interval information to the estimation integrator 123.

Based on the date-related information and the battery remaining charge amount information among the information acquired by the data acquirer 11, the battery remaining charge amount estimator 122 estimates a battery remaining charge amount in the future and generates estimated battery remaining charge amount information, and outputs the generated estimated battery remaining charge amount information to the estimation integrator 123.

The estimation integrator 123 respectively receives the estimated non-connection interval information and the estimated battery remaining charge amount information as inputted from the non-connection interval estimator 121 and the battery remaining charge amount estimator 122 and generates integrated information that integrates the estimated non-connection interval information and the estimated battery remaining charge amount information.

The data output device 13 outputs the integrated information generated by the estimation integrator 123.

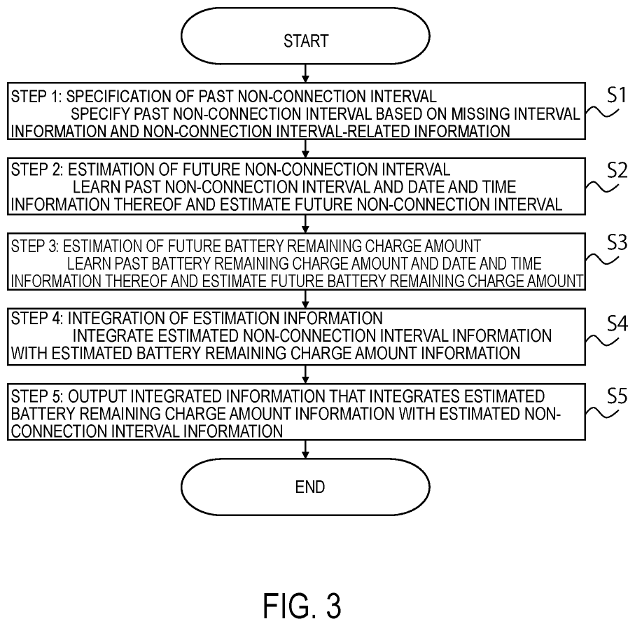

Hereinafter, a specific description of the first embodiment of the present invention will be given with reference to FIGS. 3 to 10. The following is merely an example and specification of a past non-connection interval, estimation of a non-connection interval in the future, estimation of a battery remaining charge amount in the future, and integration of estimated non-connection interval information and estimated battery remaining charge amount information need not necessarily be performed precisely as described below.

FIG. 3 is a flow chart schematically showing a procedure of estimating an absence interval and a battery remaining charge amount in the information estimation apparatus 10 according to the first embodiment of the present invention.

In step S1, the non-connection interval specifier 120 specifies a non-connection interval in the past based on inputted missing interval information and non-connection interval-related information. As described earlier, the non-connection interval-related information indicates a condition for determining a non-connection interval (in the present example, an absence interval) from the missing interval information. The non-connection interval specifier 120 detects a non-connection interval in the past by applying the condition indicated by the non-connection interval-related information to the missing interval information. While the non-connection interval may be specified for each factor such as an absence of the mobile object 21 (user), non-connection of a plug, and the like as described earlier, in the present example, a case where the factor is absence will be mainly assumed.

In step S2, the non-connection interval estimator 121 learns the past non-connection interval generated in step S1 and date and time information thereof and estimates a non-connection interval in the future. Estimated non-connection interval information representing the non-connection interval having been estimated (estimated non-connection interval) is generated. When estimating a non-connection interval for each factor, learning may be separately performed according to the distinction among different factors described earlier in the learning of a past non-connection interval.

In step S3, the battery remaining charge amount estimator 122 learns the past battery remaining charge amount and date and time information thereof and estimates a battery remaining charge amount in the future. Estimated battery remaining charge amount information representing the battery remaining charge amount having been estimated (estimated battery remaining charge amount) is generated. In steps S2 and S3, the future estimation object interval may be any finite time period length and a time interval of the estimation object interval may be any time interval equal to or longer than one minute and may differ between step S2 and step S3.

In step S4, the estimation integrator 123 integrates the estimated battery remaining charge amount information generated in step S3 and the estimated non-connection interval information generated in step S2. The integration at this point may involve simply organizing both the estimated battery remaining charge amount information and the estimated non-connection interval information in one table, deleting data of the estimated non-connection interval from data of the estimated battery remaining charge amount, or merely aligning time intervals. When there is no estimated non-connection interval, the operation (integration) of data need not be performed.

In step S5, the data output device 13 outputs the integrated information generated by the estimation integrator 123.

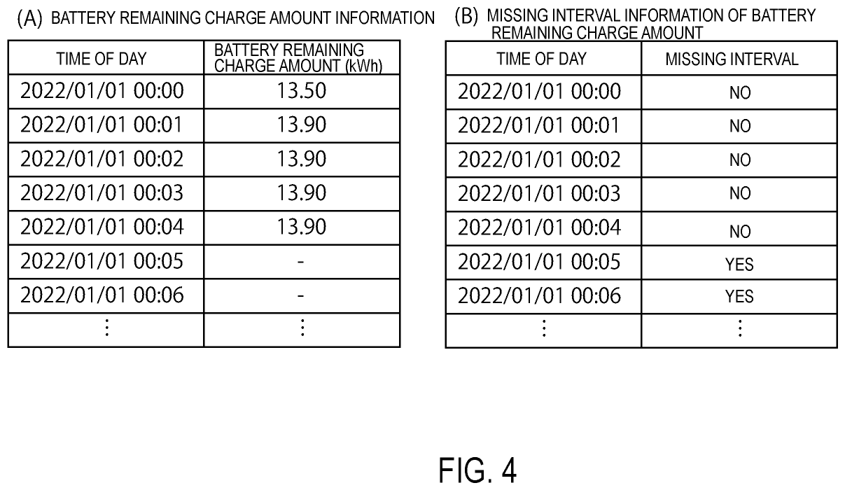

FIG. 4A is a table showing an example of battery remaining charge amount information and FIG. 4B is a table showing an example of missing interval information of battery remaining charge amount (information of past non-connection interval). In FIG. 4A, measurement information of the battery remaining charge amount of the mobile object 21 is recorded in one minute units. An interval where a measurement of the battery remaining charge amount is missing or missing and there is no value (described by a hyphen) corresponds to a missing interval. Information indicating whether or not an interval is a missing interval in one minute units is missing interval information shown in FIG. 4B. In FIG. 4B, Yes (circle) signifies a missing interval and No (cross) signifies an interval that is not a missing interval.

### (Step S1: Specification of Non-Connection Interval in the Past)

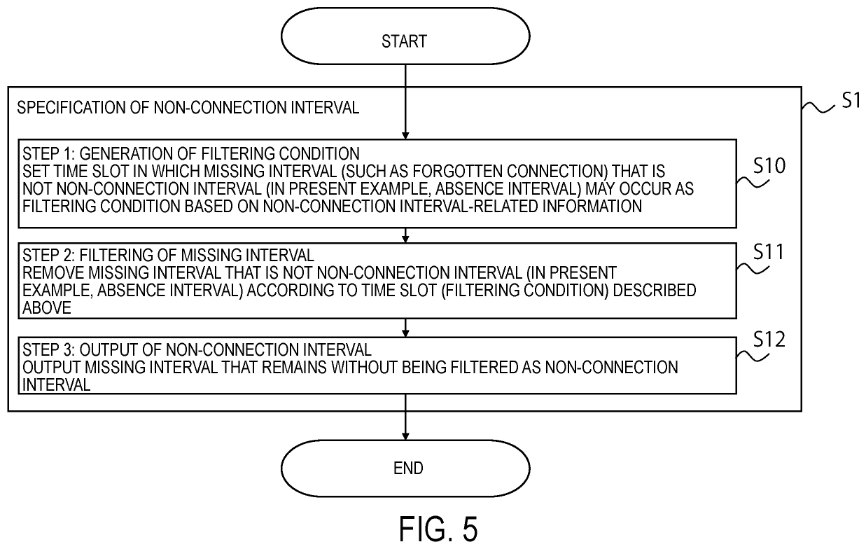

FIG. 5 is a detailed flow chart of step S1 which schematically shows an example of specific processing in a procedure by which the non-connection interval specifier 120 specifies a non-connection interval (an absence interval in the present example) in the past and obtains non-connection interval information. An example of specific processing in step S1 for obtaining a non-connection interval will be described based on FIG. 5. In the following description, note that a non-connection interval is a time slot during which a user is absent from the consumer's residence 19 and a time slot during which the user is present but has forgotten to connect the mobile object 21 is not handled as a non-connection interval. However, the present embodiment is not limited to this handling and, when a non-connection interval is defined for each factor, a non-connection interval in the case of a forgotten connection and a non-connection interval in the case of absence may be separately specified.

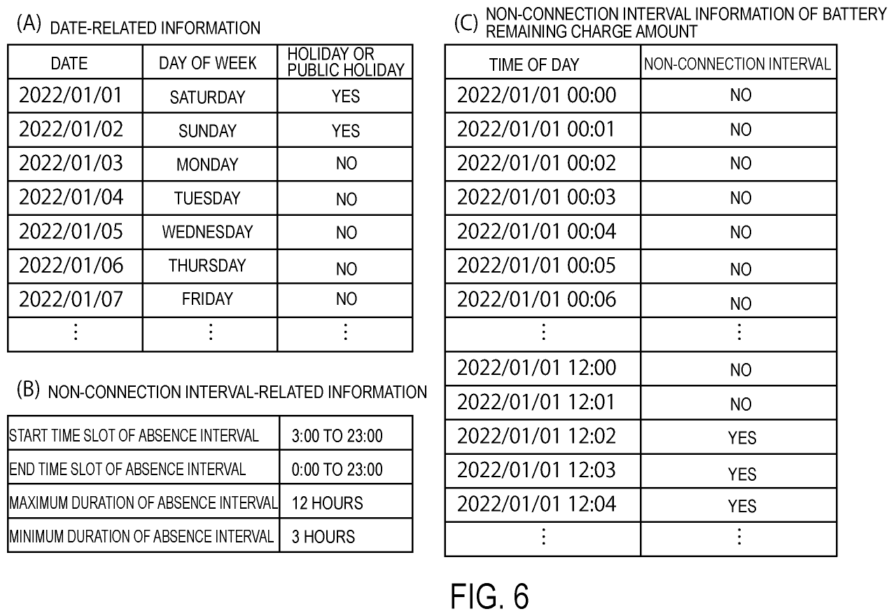

FIG. 6A is a table showing an example of date-related information, FIG. 6B is a table showing an example of non-connection interval-related information, and FIG. 6C is a table showing an example of non-connection interval information generated as a result of the processing of step S1.

In step S10 in FIG. 5, the non-connection interval specifier 120 specifies, based on non-connection interval-related information, a time slot during which a missing interval (a missing interval that is not an absence interval) such as an unconnected time interval due to forgotten connection or the like may occur in the battery remaining charge amount measurer 17. When the non-connection interval-related information shown in FIG. 6B is used, since a missing interval satisfying a condition requiring that a start time slot of an absence interval is from 3:00 to 23:00, an end time slot of the absence interval is from 0:00 to 23:00, a maximum duration of the absence interval is 12 hours, and a minimum duration of the absence interval is 3 hours is defined as an absence interval (a non-connection interval that is an object), an interval other than an interval (time slot) satisfying a condition defined in the non-connection interval-related information among the missing intervals shown in the missing interval information is determined as a missing interval that is not an object non-connection interval. In other words, a time of day denoted by No (cross) (not a missing interval) in the missing interval information shown in FIG. 4B means that at least the mobile object 21 is present at the consumer's residence 19. Therefore, using the non-connection interval-related information, whether or not the mobile object 21 is absent or not from the consumer's residence 19 at a time of day denoted by Yes (circle) (missing interval) in the missing interval information is estimated or determined. While the non-connection interval-related information in FIG. 6B is commonly applied to all days, the non-connection interval-related information may be defined according to a day attribute such as a day of week, a holiday or a public holiday, or the like.

In step S11, the non-connection interval specifier 120 deletes a missing interval that is not an object non-connection interval (absence interval) determined in step S10 from the missing interval information inputted to the non-connection interval specifier 120. In the example shown in FIG. 6C, a missing interval starting at 00:05 on 2022/01/01 in the missing interval information of battery remaining charge amount in FIG. 4B is not determined as an absence interval (the missing interval is determined as a missing interval (interval of forgotten connection) that is not an object non-connection interval) since the missing interval does not satisfy the determination criterion (from 3:00 to 23:00) of the start time slot of an absence interval described earlier and is deleted from the non-connection interval information of battery remaining charge amount shown in FIG. 6C.

In step S12, the non-connection interval specifier 120 determines a missing interval that remains without being deleted in step S11 as an object non-connection interval (absence interval) and generates non-connection interval information representing the determined non-connection interval. The non-connection interval information generated at this point is, for example, data that is formatted as shown in FIG. 6C. The data shown in FIG. 6C includes information (determination result) on whether or not an interval is a non-connection interval in one minute units.

### (Step S2: Estimation of Non-Connection Interval)

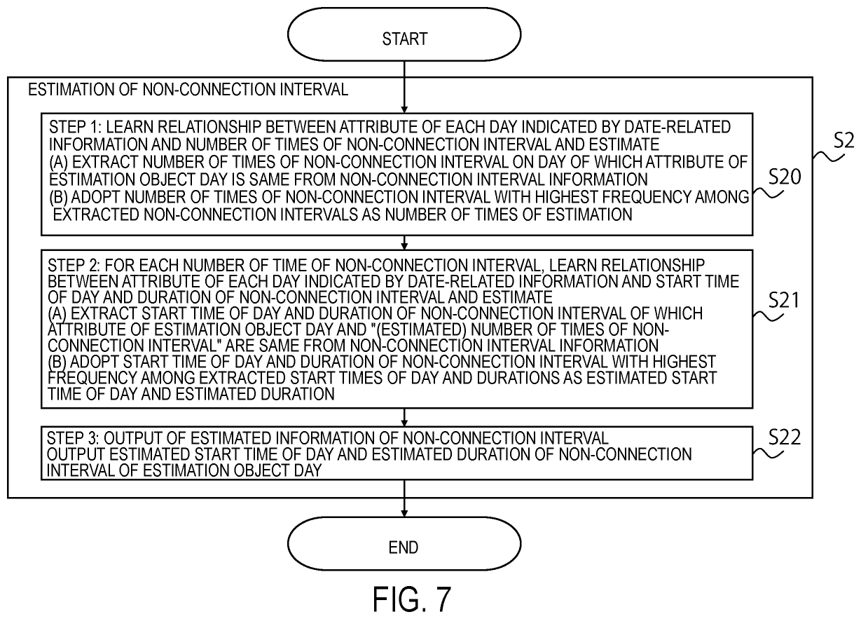

FIG. 7 is a flow chart schematically showing an example of a procedure by which the non-connection interval estimator 121 estimates a non-connection interval (an absence interval in the present example). An example of specific processing in step S2 for estimating a non-connection interval will be described based on FIG. 7.

The number of times of non-connection intervals and a start time of day or a duration of a non-connection interval fluctuates in relation to a day of week or a holiday or public holiday and is conceivably consistent in relation to a day of week or a holiday or public holiday. Therefore, the number of times of non-connection intervals and a start time of day or a duration of a non-connection interval can be estimated from date-related information. For example, a non-connection interval that is generated by using an electric vehicle to become absent from the consumer's residence 19 from 8:00 to 19:00 on a weekday is conceivably likely to be also generated in the future from 8:00 to 19:00 on a weekday.

In step S20, the non-connection interval estimator 121 counts the number of times of non-connection intervals for each day, learns a relationship between an attribute (day of week or a holiday or public holiday) for each day indicated by the date-related information and the number of times of non-connection intervals on each day, and estimates the number of times of non-connection intervals on an estimation object day based on date-related information. When counting the number of times of non-connection intervals, a continuous time period during which the mobile object 21 is not connected is counted as 1.

In the example of the date-related information shown in FIG. 6A, information on a day of week or a holiday or public holiday is included for each day and can be associated with the number of times of non-connection intervals in each day extracted in the non-connection interval information shown in FIG. 6C. For example, when 2022/01/07 is set as an estimation object day, since the date-related information of 2022/01/07 is “a Friday and not a holiday or public holiday”, a numerical value (for example, 1) with a highest frequency among the number of times of non-connection intervals of past days being “a Friday and not a holiday or public holiday” can be adopted as the estimated number of times of non-connection intervals on 2022/01/07.

In step S21, for each number of time of non-connection intervals on each past day, a relationship between date-related information and a start time of day and a duration of non-connection intervals is learned and a start time of day and a duration of non-connection intervals on an estimation object day is estimated based on date-related information using a relationship associated with the number of times of non-connection intervals estimated in step S20.

Specifically, a start time of day and a duration of a non-connection interval in the past related to a day on which the number of times of non-connection intervals is the same as the number of times of non-connection intervals estimated in step S20 are acquired and a relationship between the acquired information (a start time of day and a duration of a non-connection interval) and an attribute of date-related information (a day of week, a holiday or public holiday, or the like) is learned. Furthermore, the start time of day and the duration of a non-connection interval on the estimation object day is estimated based on the learned relationship and an attribute of the estimation object day.

In the example described above in which 2022/01/07 is the estimation object day, since the number of times of non-connection intervals on each day is estimated as one, all days in the past on which “the number of times of non-connection intervals per day is one” and which are “a Friday and not a holiday or public holiday” can be extracted and numerical values with respectively highest frequencies among the start time of day and the duration of non-connection intervals on all extracted days (as an example, a start time of day of 12:30 and a duration of 4 hours) can be adopted as the start time of day and the duration of non-connection intervals on 2022/01/07.

In step S22, information indicating whether or not an interval is a connection interval per one minute units is generated with respect to the estimation object day based on the estimated start time of day and the estimated duration of the non-connection interval on the estimation object day estimated in step S21 and the generated information is outputted as estimated information of a non-connection interval on the estimation object day.

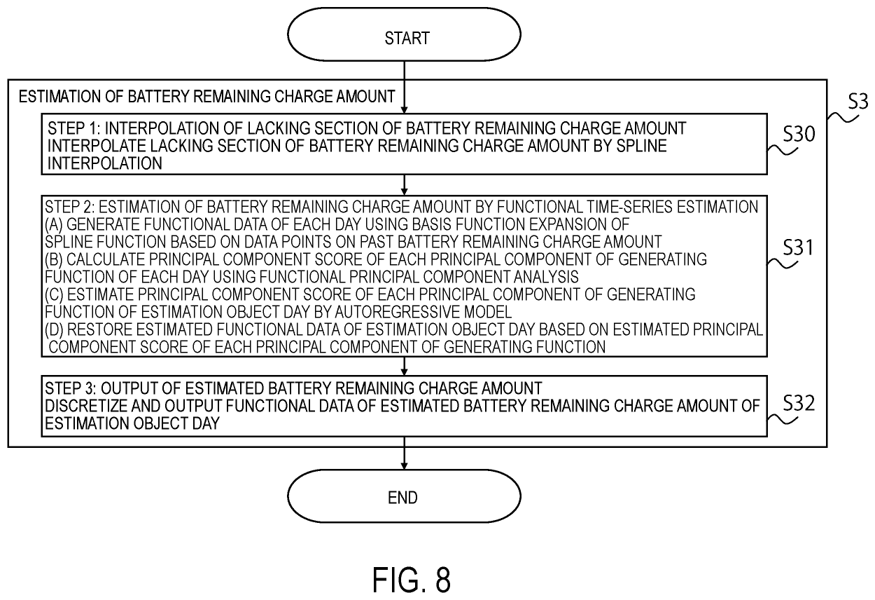

FIG. 8 is a flow chart schematically showing an example of a procedure by which the battery remaining charge amount estimator 122 estimates battery remaining charge amount. An example of specific processing in step S3 for estimating a battery remaining charge amount will be described based on FIG. 8.

In the storage battery 21A of the mobile object 21 connected to the battery remaining charge amount measurer 17 in the consumer's residence 19, a battery remaining charge amount fluctuates as the storage battery 21A is charged and discharged under the control of the charge/discharge control device 18 in the consumer's residence 19. While dependent on settings such as an operating mode, the control by the charge/discharge control device 18 is often performed as periodic control in a daily cycle and, in this case, a fluctuation of battery remaining charge amount for each day is similar from one day to the next. Therefore, by capturing features of periodic control that occurred in the past, a battery remaining charge amount while being connected to the charge/discharge control device 18 in the future can be estimated. In the following example, a battery remaining charge amount curve of each day is assumed to be functional data and a future battery remaining charge amount curve is estimated by function time-series estimation.

In step S30, the battery remaining charge amount estimator 122 interpolates missing intervals of the battery remaining charge amount by spline interpolation. Due to the interpolation, the missing intervals of the battery remaining charge amount are smoothly connected and battery remaining charge amount data without missing intervals is generated. In the example of the battery remaining charge amount information shown in FIG. 4A, there are missing intervals (described by a hyphen) where a measurement is missing and there is no value after 00:05 on 2022/01/01, and values of such intervals are filled by spline interpolation.

In step S31, functional data is created using basis function expansion of the spline function based on data points on each day of the battery remaining charge amount interpolated in step S30. Furthermore, functional data of a battery remaining charge amount on an estimation object day is estimated using functional principal component analysis and an autoregressive model.

Specifically, a principal component score that fluctuates daily of each principal component of generating function is calculated by functional principal component analysis with respect to functional data of battery remaining charge amount, an autoregressive model of the principal component score to be time-series data is learned, a principal component score of the estimation object day is estimated based on the autoregressive model, and functional data of battery remaining charge amount of the estimation object day is restored based on the estimated principal component score of each principal component of generating function.

An example in which the estimation object day is 2022/01/07 and battery remaining charge amount information of 28 days (2021/12/10 to 2022/01/06) preceding the estimation object day is used will be described.

First, a missing interval of the battery remaining charge amount from 2021/12/10 to 2022/01/06 is interpolated by spline interpolation.

Next, using basis function expansion of the spline function based on data points of the interpolated battery remaining charge amount, functional data of the battery remaining charge amount is obtained for each day. In other words, 28 pieces of functional data (f₁, f₂, . . . , f₂₈) corresponding to 28 days are obtained. Functional principal component analysis is used with respect to the functional data to calculate a principal component score that fluctuates daily of each principal component of generating function. When using six principal components of generating function (ϕ₁, ϕ₂, . . . , ϕ₆), 28 days' worth of six principal component scores are obtained as follows.
(β_{1,1}, β_{1,2}, . . . , β_{1,6}), (β_{2,1}, β_{2,2}, . . . , β_{2,6}), . . . , (β_{28,1}, β_{28,2}, . . . , β_{28,6})

In addition, since each principal component score is time-series data obtained daily, an autoregressive model can be learned with a principal component score (β_{1,k}, β_{2,k}, . . . , β_{28,k}) of the 28 days and a principal component score \hat{ϕ}_{29,k} of one day later (2022/01/07) can be estimated, where k denotes a k-th principal component of generating function.

Estimated functional data \hat{f}₂₉ of 2022/01/07 is restored based on the six principal component scores (\hat{β}_{29,1}, \hat{β}_{29,2}, . . . , \hat{β}_{29,6}) corresponding to the six estimated principal components of generating function of 2022/01/07.

In step S32, the functional data of the battery remaining charge amount of the estimation object day estimated in step S31 is discretized and outputted. The discretization is performed so as to equal battery remaining charge amount information. Referring to the battery remaining charge amount information in FIG. 4A, battery remaining charge amount in one minute units of the estimation object day may be outputted.

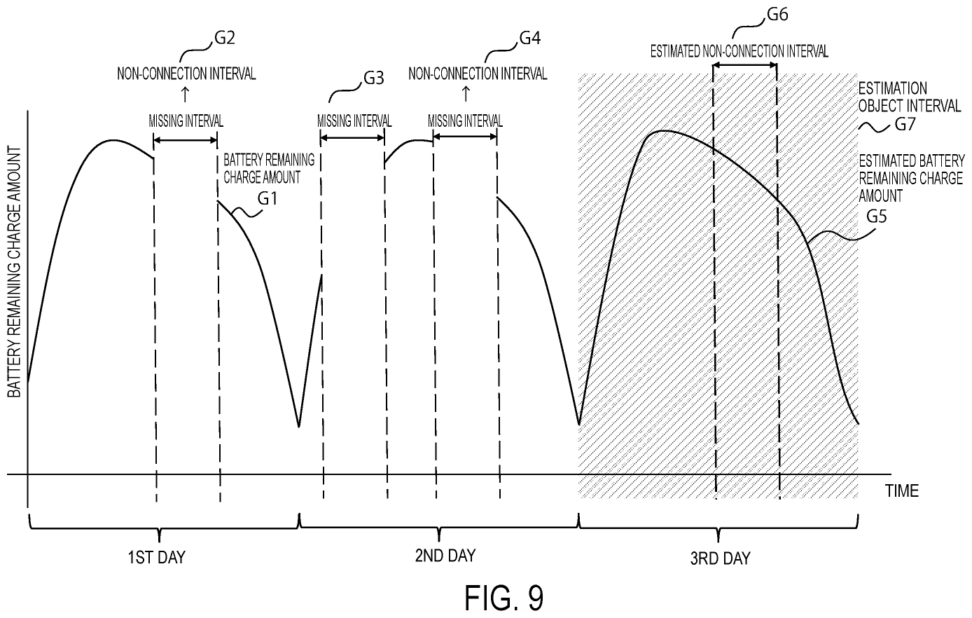

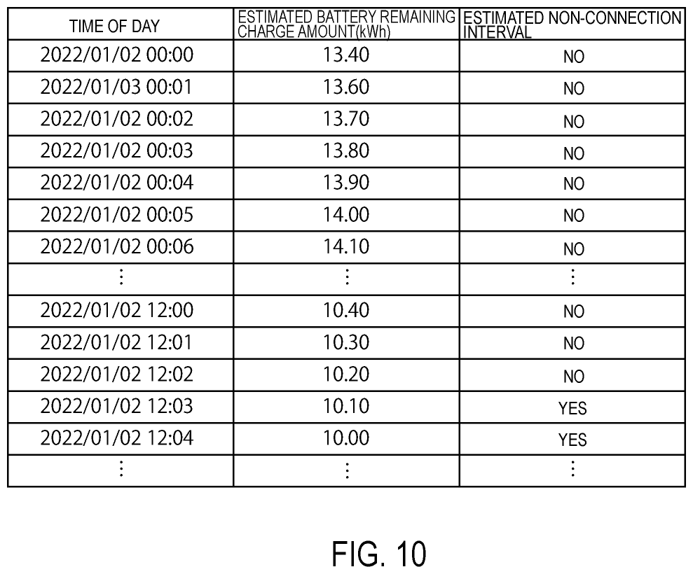

FIG. 9 shows an example of output data including integrated information T in which estimated non-connection interval information and estimated battery remaining charge amount information are integrated by the estimation integrator 123. FIG. 10 shows, in a table format, the integrated information T shown in FIG. 9.

The integrated information T is generated by the information estimation apparatus 10 regarding an estimation object interval G7 (estimation object day (3rd day)) that is shown hatched in FIG. 9. The integrated information T includes a graph of an estimated battery remaining charge amount G5 and information of an estimated non-connection interval G6. In addition, besides the integrated information T, the output data in FIG. 9 shows a battery remaining charge amount G1 of a 1st day and a 2nd day as a graph and also shows information indicating missing intervals G2, G3, and G4. The first missing interval G3 on the 2nd day is a missing interval that is not an object non-connection interval (absence interval) (for example, a missing interval due to a forgotten connection where the mobile object 21 is present at the consumer's residence 19 but the mobile object 21 is not connected to the battery remaining charge amount measurer 17). On the other hand, the missing interval G2 on the 1st day and the second missing interval G4 on the 2nd day are past non-connection intervals (absence intervals) generated by the non-connection interval specifier 120 as a non-connection interval (absence interval) or a second non-connection interval to be an object. When an interval of a forgotten connection or the like is to be made an object of estimation, the non-connection interval of a forgotten connection in the estimation object interval G7 on the 3rd day may also be included. While an estimated battery remaining charge amount in the estimated non-connection interval G6 is also estimated in the example shown in FIG. 9, the estimation of a battery remaining charge amount in the estimated non-connection interval G6 may be omitted. A battery remaining charge amount in a connection interval (second connection interval) of the mobile object 21 need only be estimated in at least the estimation object interval G7.

As described above, according to the present embodiment, information related to a time period during which a storage battery included in a mobile object is connected to a charge connector for charge and discharge and a battery remaining charge amount during the time period can be estimated with accuracy. When there is a charge/discharge plan of the storage battery at a consumer's residence or when the mobile object is capable of acquiring information on a battery remaining charge amount (for example, when the mobile object is equipped with a mechanism for acquiring battery remaining charge amount information from the storage battery), estimation can be performed with high accuracy by acquiring the information from the mobile object via communication or the like while referring to the plan. However, estimation with high accuracy is usually difficult when there is no charge/discharge plan of a storage battery included in a mobile object at a consumer's residence or when the mobile object is incapable of acquiring information on a battery remaining charge amount. In the present embodiment, using the battery remaining charge amount information measured by the battery remaining charge amount measurer 17 and missing interval information enables a connection time period during which a mobile object is connected to a charge connector and a battery remaining charge amount during the connection time period to be estimated with high accuracy even when the plan described above is not available or when the mobile object is incapable of acquiring information on a battery remaining charge amount.

### Second Embodiment

As a second embodiment of the present invention, an embodiment in a case where a total DR (demand response)-enabled amount of a single or a plurality of consumers is calculated based on estimated battery remaining charge amount information of the single or the plurality of consumers will be described.

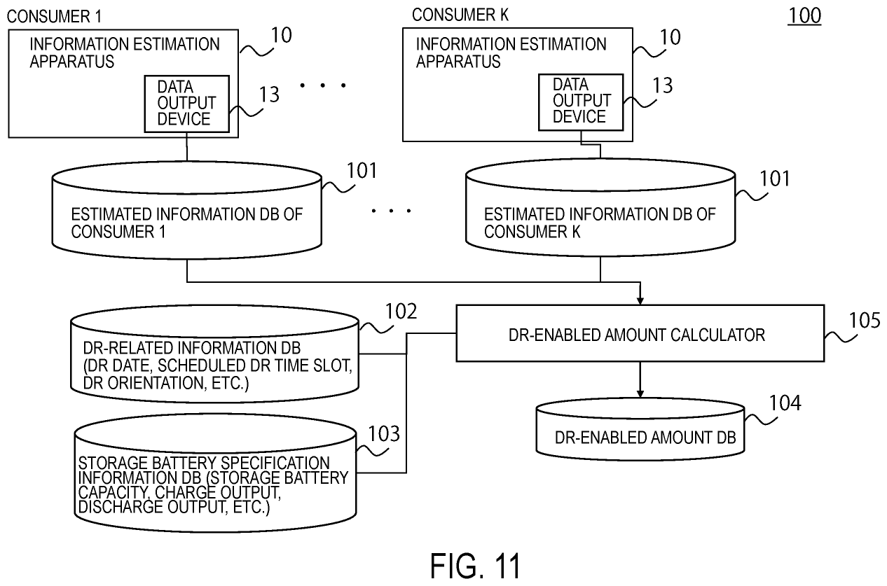

FIG. 11 is a block diagram showing an example of a DR-enabled amount calculation apparatus 100 as an information processing apparatus according to the second embodiment. Here, a case where there are K-number of consumers from consumer 1 to consumer K will be described. The DR-enabled amount calculation apparatus 100 shown in FIG. 11 includes the information estimation apparatus 10 for each of the plurality of consumers 1 to K, an estimated information DB 101 for each of the plurality of consumers 1 to K that stores integrated information (estimated battery remaining charge amount information and estimated non-connection interval information) generated by the information estimation apparatus 10, a demand response-related information (DR-related information) DB 102 that stores information related to DR, a storage battery specification information DB 103 that stores specification information of the storage battery 21A of each of the consumers 1 to K, a DR-enabled amount calculator 105 that calculates a DR-enabled amount of all consumers, and an overall DR-enabled amount DB 104 that stores the calculated DR-enabled amount of all consumers. The information estimation apparatus 10 of each of the plurality of consumers 1 to K is configured in a similar manner to the first embodiment.

Each estimated information DB 101 stores integrated information (estimated battery remaining charge amount information and estimated non-connection interval information) generated by the information estimation apparatus 10 for each of the consumers 1 to K.

The DR-related information DB 102 stores information related to a DR such as a DR date, a scheduled DR time slot, an orientation of DR, and a block length. It is assumed that there are two DR orientations: a downward DR (DR that reduces a meter value; in the present embodiment, discharge is performed) and an upward DR (DR that increases a meter value; in the present embodiment, charge is performed).

In addition, a block length refers to a time unit for calculating a DR-enabled amount of power (a discharge amount in the case of a downward DR; a charge amount in the case of an upward DR). For example, when the scheduled DR time slot is three hours from 18:00 to 21:00 and the block length is 30 minutes, a DR-enabled amount is to be calculated with respect to six blocks obtained by breaking down three hours into units of 30 minutes. In accordance with a type of DR, there may be cases where a downward (or upward) enabled amount for every 30 minutes may be calculated, cases where an enabled amount for every five minutes may be calculated, and the like. By using a block length, an enabled amount in accordance with a time unit to be applied can be calculated.

The storage battery specification information DB 103 stores specification information of the storage battery 21A such as a storage battery capacity, a charge output, and a discharge output for each of the consumers 1 to K.

The overall DR-enabled amount DB 104 stores a DR-enabled amount of all consumers calculated for each block of the scheduled DR time slot by the DR-enabled amount calculator 105.

Hereinafter, assuming that K=4, specific examples of various information and operations will be described using a case of four consumers from consumer 1 to consumer 4 as an example.

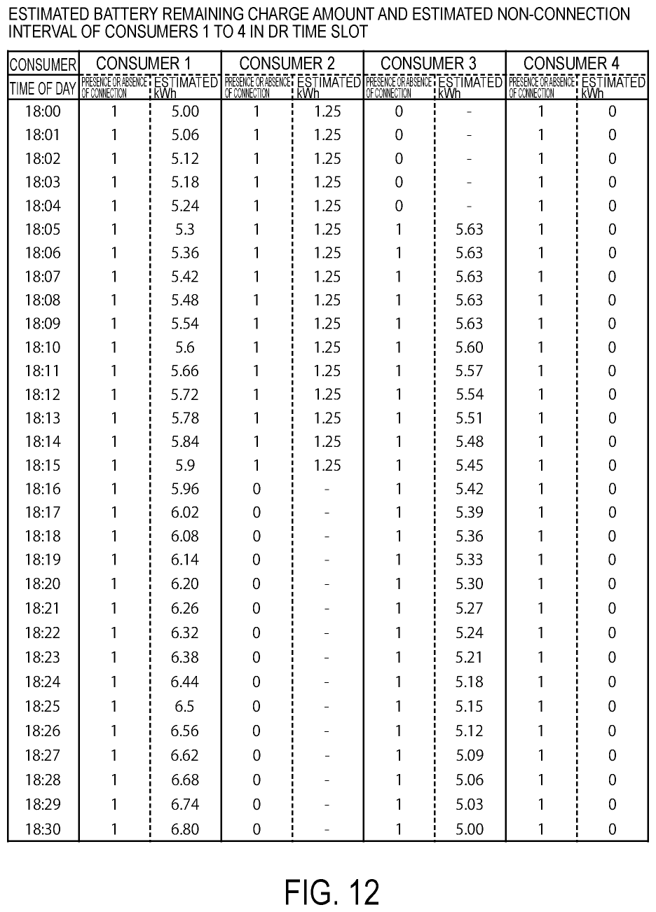

FIG. 12 shows an example of estimated battery remaining charge amount information and estimated non-connection interval information stored in the estimated information DB 101 of each of the consumers 1 to K. In this case, an estimation of presence or absence of connection (1 when present and 0 when absent) and an estimated SoC (in kWh units) of each consumer during a 30-minute period from 18:00 to 18:30 are shown per minute. A result of estimation of presence or absence of connection being present corresponds to a case where the estimated non-connection interval according to the first embodiment is No (cross) and a result of estimation of presence or absence of connection being absent corresponds to a case where the estimated non-connection interval according to the first embodiment is Yes (circle) (refer to FIG. 10). The estimated SoC corresponds to the estimated battery remaining charge amount according to the first embodiment.

The consumer 1 is estimated to have a SoC of 5.00 kWh at a time point of 18:00 and, subsequently, the mobile object 21 is constantly connected to the battery remaining charge amount measurer 17 and the mobile object 21 is estimated to be continuously charged. The estimated SoC increases by 0.06 kWh every minute.

SoC of the consumer 2 is estimated to remain at 1.25 kWh (in other words, neither charge nor discharge is to be performed) until 18:15 in a state where the mobile object 21 is connected to the battery remaining charge amount measurer 17. The mobile object 21 is estimated to become absent (unconnected) after 18:15.

With the consumer 3, while the mobile object 21 is estimated to be absent (unconnected) until 18:05, the mobile object 21 with the storage battery 21A of which a SoC is 5.63 kWh is connected to the battery remaining charge amount measurer 17 at 18:05, the SoC remains at 5.63 kWh until 18:09, and discharge at 0.03 kWh per minute is estimated to be performed from 18:10.

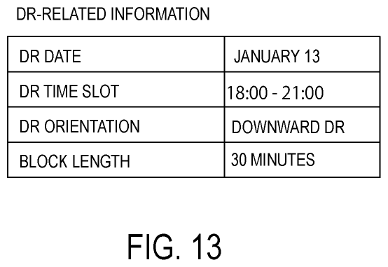

FIG. 13 is an example of DR-related information stored in the DR-related information DB 102. A case where a downward DR is made from 18:00 to 21:00 on January 13 and a block length of 30 minutes is designated is shown. Since the block length is 30 minutes, a DR-enabled amount (in this case, a discharge amount) must be calculated with respect to six blocks obtained by breaking down the three hours from 18:00 to 21:00 into units of 30 minutes.

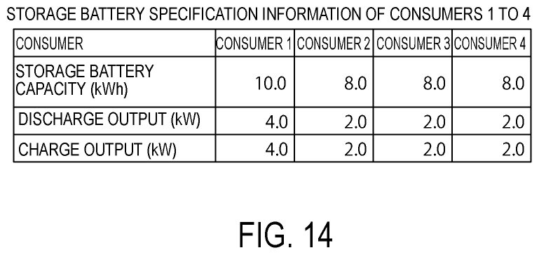

FIG. 14 is an example of storage battery specification information of the consumers 1 to 4 stored in the storage battery specification information DB 103. In this case, the storage battery 21A of the consumer 1 has a capacity of 10.0 kWh and a discharge output and a charge output of 4.0 kW. In addition, the storage battery 21A of the consumers 2 to 4 has a capacity of 8.0 kWh and a discharge output and a charge output of 2.0 kW.

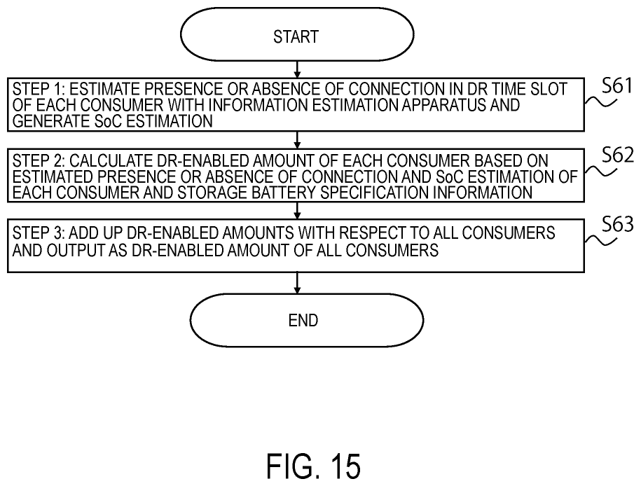

FIG. 15 is a flow chart schematically showing an example of processing of the DR-enabled amount calculator 105.

First, in step S61, based on integrated information generated by the information estimation apparatus 10 of each consumer, information indicating an estimation of a presence or absence of connection and an estimation of a SoC of the mobile object 21 during a DR time slot of each consumer is generated. Accordingly, estimated information of the presence or absence of connection (estimated non-connection interval information) and estimated information of a SoC (estimated battery remaining charge amount information) in the DR time slot such as that shown in FIG. 12 described above is created.

Next, in step S62, based on the estimation of the presence or absence of connection and the SoC estimation of each consumer and the storage battery specification information of each consumer, a DR-enabled amount (a dischargeable amount) of each consumer is calculated.

Finally, in step S63, a sum of the DR-enabled amounts of all consumers is calculated and outputted as a total DR-enabled amount. Information on the total DR-enabled amount of all consumers may be transmitted to a DR business operator (an electric power company or the like). Accordingly, since the DR business operator can comprehend a power resource that can be used with respect to DR with high accuracy, supply and demand control that is suitable for procuring power can be performed. For example, when there is a shortage of power resources, a power amount that needs to be procured in a power transaction market can also be comprehended with high accuracy.

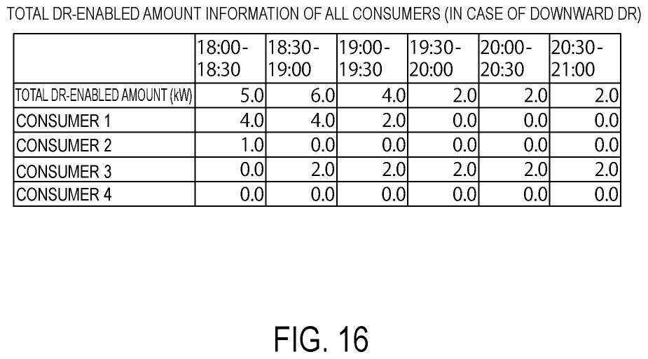

FIG. 16 shows an example of a DR-enabled amount of each consumer and a total DR-enabled amount of all consumers calculated for each of a plurality of DR time slots. More specifically, for each block of 18:00 to 18:30, 18:30 to 19:00, 19:00 to 19:30, 19:30 to 20:00, 20:00 to 20:30, and 20:30 to 21:00, the total DR-enabled amount of all consumers and a breakdown of each consumer are shown in average kW (note that since each cell indicates an average kW for every 30 minutes, the values must be halved when using kWh units). For example, the total DR-enabled amount during 18:30 to 19:00 is 6.0 kW that can be broken down to 4.0 kW for consumer 1 and 2.0 kW for consumer 3.

Next, an example of calculating the DR-enabled amount of each consumer and a total DR-enabled amount of all consumers shown in FIG. 16 by the processing of steps S62 and S63 based on the information shown in FIGS. 12 to 14 will be shown.

First, with respect to consumer 1, since a SoC estimation is 5.0 kWh and a discharge output is 4.0 kWh at 18:00, it is shown that when discharge output is to be continued at the maximum output of 4.0 kWh, the discharge output can be continued for 1 hour and 15 minutes. Therefore, when a DR-enabled output amount is calculated every 30 minutes, it is shown that an average output of 4.0 kW is suppliable (dischargeable) with respect to the blocks of 18:00 to 18:30 and 18:30 to 19:00 and an average output of 2.0 kW is suppliable (dischargeable) with respect to the block of 19:00 to 19:30.

Next, with respect to consumer 2, although a SoC estimation at 18:00 is 1.25 KW, since the mobile object 21 becomes unconnected at 18:15, discharge can only be performed for the first 15 minutes. In addition, since discharge output is 2.0 kW, an average output of 1.0 kW is suppliable with respect to the block of 18:00 to 18:30. While calculations have been performed on the assumption that the mobile object 21 is reliably connected until 18:15, when it is highly likely that the mobile object 21 is to become unconnected before 18:15, the mobile object 21 may be considered discharge-disabled and a suppliable amount may be set to 0 kW.

Next, with respect to consumer 3, since the mobile object 21 is predicted to be absent (unconnected) at 18:00, discharge output is considered unsuppliable until 18:30. In this case, a suppliable amount from 18:00 to 18:30 is 0 KW. On the other hand, since a SoC estimation at 18:30 is 5.0 kWh, it is shown that when discharge output is to be continued at the maximum discharge output of 2 kW, the discharge output can be continued for 2 hour and 30 minutes. Therefore, for each block of 18:30 to 19:00, 19:00 to 19:30, 19:30 to 20:00, 20:00 to 20:30, and 20:30 to 21:00, an average output of 2 kW is suppliable.

Next, with respect to consumer 4, although it is estimated that the mobile object 21 is continuously connected from 18:00, since a SoC estimation is 0 kW, a suppliable amount is 0 kW.

The average kW of a breakdown of each consumer (a DR-enabled amount for each consumer) in FIG. 16 combines the calculation results described above. In addition, by adding up the DR-enabled amounts of the respective consumers for each DR time slot, a total DR-enabled amount of all consumers can be calculated.

While a case of downward DR has been described, in a case of upward DR, a DR-enabled amount of each consumer and a total DR-enabled amount of all consumers can be calculated by processing similar to that described above by replacing “SoC” with “capacity-SoC” (where “-” represents subtraction) and replacing “discharge output” with “charge output”.

Hereinafter, a specific example of a case of calculating a DR-enabled amount of upward DR from 18:00 to 21:00 will be shown.

With respect to consumer 1, since an upward remaining power at 18:00 is

capacity−SoC estimation at 18:00=10.0−5.0=5.0 kWh, duration is (5.0/4.0=1.25 h=) 1 hour 15 minutes.

With respect to consumer 2, since it is predicted that the mobile object 21 is only connected from 18:00 to 18:15, 1 kW that is half of a charge output of 2.0 kW is chargeable in a similar manner to the case of downward DR.

In addition, with respect to consumer 3, since an upward remaining power at 18:30 is

capacity−SoC estimation at 18:30=8.0−5.0=3.0 kWh and charge output is 2.0 kW, duration is (3.0/2.0=1.5 h=) 1 hour 30 minutes.

On the other hand, with respect to consumer 4, since an upward remaining power at 18:00 is

capacity−SoC estimation at 18:00=8.0−0.0=8.0 kWh and charge output is 2.0 KW, charge can be continuously performed from 18:00 to 21:00.

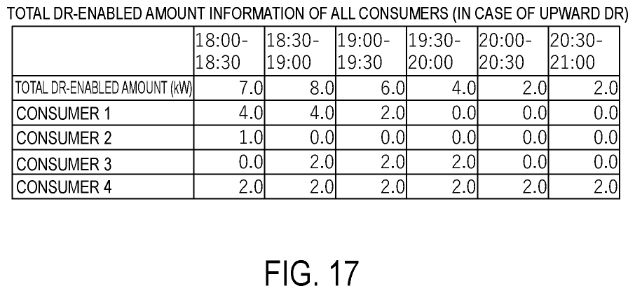

FIG. 17 shows an example of a DR-enabled amount of each consumer and a total DR-enabled amount of all consumers in the case of upward DR that are generated based on the calculations described above.

While the total DR-enabled amount of all consumers is calculated based on discharge or charge at maximum output in the description given above, when leveling the DR-enabled amounts of the respective blocks of DR time slots or the like, output of discharge or charge may be adjusted.

According to the method described above, even when there is a possibility that the mobile object 21 including a storage battery may become unconnected, a DR-enabled amount of a single consumer or each of a plurality of consumers and a total DR-enabled amount of a plurality of consumers can be calculated with high accuracy.

### (Application)

A total DR-enabled amount of all consumers can be used to determine an amount of selling offers in a power transaction market. For example, the total DR-enabled amount of a DR time slot corresponding to a time slot during which a selling offer is made is used as a power amount of which a selling offer can be made. The DR-enabled amount calculation apparatus 100 associates the total DR-enabled amount stored in the overall DR-enabled amount DB 104 with information indicating the time slot during which the total DR-enabled amount had been calculated and transmits the associated information to an apparatus of a DR business operator or a bidding entity. Based on the received information, the apparatus of the DR business operator or the bidding entity determines an amount of offers that can be placed during a bidding time slot and transmits order data of the selling offer in the determined offer amount to an apparatus of the power transaction market. Since the total DR-enabled amount has been calculated with high accuracy, a surplus power amount available for sale can be estimated with high accuracy and, at the same time, a risk of being unable to provide a successful bidder with an actually contracted power amount after the sell order is contracted can be reduced.

### Third Embodiment

As a third embodiment of the present invention, an embodiment in a case where a required charging amount is calculated according to a use start time of day of a mobile object 21 including a storage battery and a necessary battery remaining charge amount information at the time of day based on integrated information (estimated battery remaining charge amount information and estimated non-connection interval information) generated with respect to a single consumer will be described.

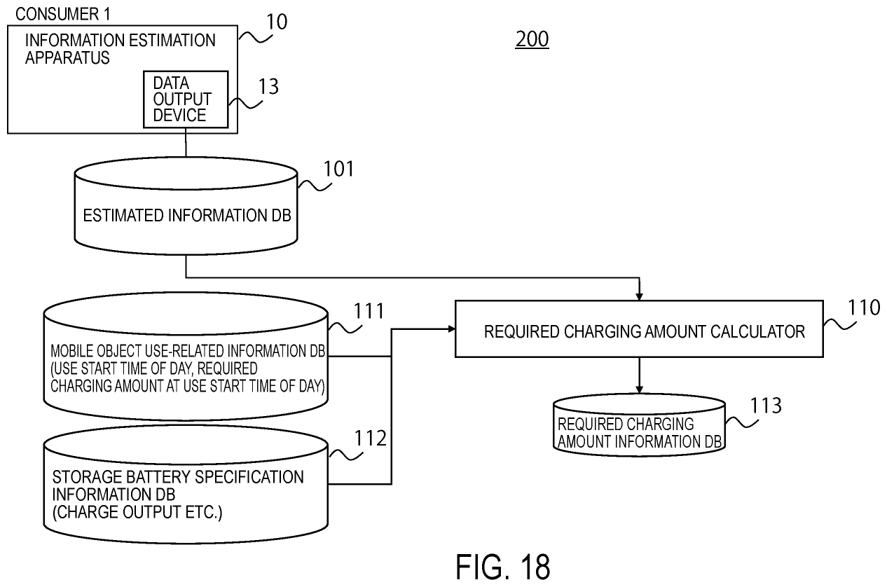

FIG. 18 is a block diagram showing an example of a required charging amount calculation apparatus 200 as an information processing apparatus according to the third embodiment. The required charging amount calculation apparatus 200 shown in FIG. 18 includes the information estimation apparatus 10 of the consumer 1, the estimated information DB 101 that stores integrated information (estimated battery remaining charge amount information and estimated non-connection interval information) generated by the information estimation apparatus 10, a mobile object use-related information DB 111 that stores information related to the use of the mobile object 21, a storage battery specification information DB 112 that stores specification information of the storage battery 21A of the consumer 1, a required charging amount calculator 110 that calculates a required charging amount of the mobile object 21, and a required charging amount information DB 113 that stores required charging amount information representing the required charging amount calculated by the required charging amount calculator 110.

The estimated information DB 101 stores integrated information (estimated battery remaining charge amount information and estimated non-connection interval information) generated by the information estimation apparatus 10 of the consumer 1.

The mobile object use-related information DB 111 stores information such as a use start time of day, a necessary storage amount at the use start time of day, and the like of the mobile object 21 as mobile object use-related information.

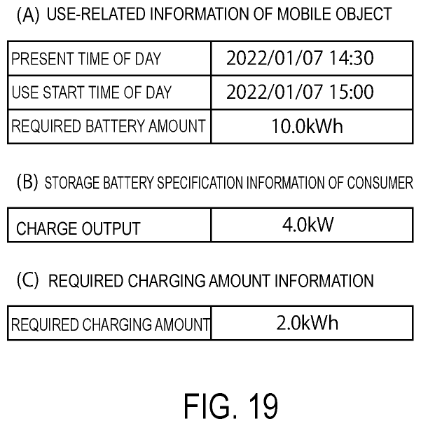

FIG. 19A shows an example of mobile object use-related information stored in the mobile object use-related information DB 111. Information such as a present time of day, a use start time of day, a necessary storage amount at the use start time of day, and the like of the mobile object 21 is stored. The present time of day is to be updated in predetermined time units.

The storage battery specification information DB 112 stores specification information of the storage battery 21A.

FIG. 19B shows an example of specification information stored in the storage battery specification information DB 112. Information related to performance of the storage battery such as a charge output is stored.

The required charging amount information DB 113 stores required charging amount information that is information on a charging amount necessary until the use start time of day which is calculated by the required charging amount calculator 110.

FIG. 19C shows an example of required charging amount information stored in the required charging amount information DB 113.

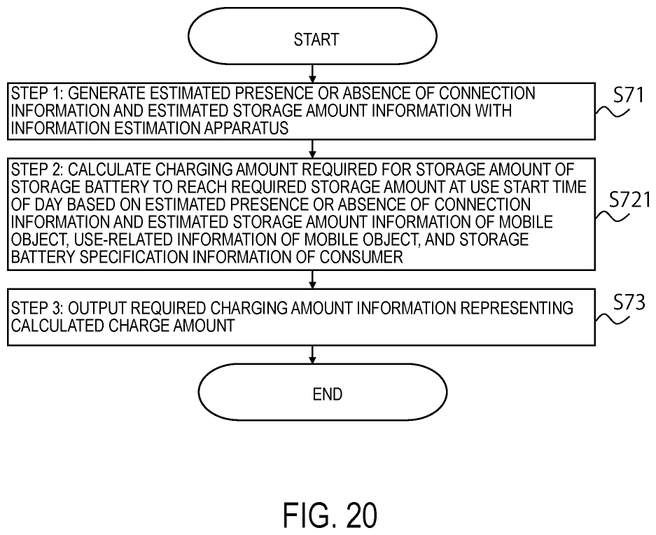

FIG. 20 is a flow chart schematically showing an example of a procedure by which the required charging amount calculator 110 calculates a required charging amount. A method of calculating a required charging amount in the third embodiment of the present invention will be described based on FIG. 20.

In step S71, a non-connection interval and a battery remaining charge amount are estimated by the information estimation apparatus 10 and estimated non-connection interval information and estimated battery remaining charge amount information are stored in the estimated information DB 101.

In step S72, the required charging amount calculator 110 reads the estimated non-connection interval information and the estimated battery remaining charge amount information from the estimated information DB 101, respectively reads information from the mobile object use-related information DB 111 and the storage battery specification information DB 112, and calculates a charging amount necessary until the use start time of day of the mobile object 21. Specifically, the required charging amount can be calculated as follows.

The required charging amount calculator 110 calculates the required charging amount from a difference between a required charging amount at the use start time of day included in the mobile object use-related information and an estimated battery remaining charge amount at the use start time of day as specified from the estimated battery remaining charge amount information.

In the example shown in FIG. 19, the use start time of day is 15:00 on 2022/01/07 and a stored amount of 10.0 kWh is necessary at this time of day. When an estimated battery remaining charge amount at 15:00 on 2022/01/07 is 8.0 kWh, a charge amount necessary until the use start time of day can be calculated as 2.0 kWh being a difference between the values.

A maximum chargeable amount until the use start time of day can be calculated based on a time period between the present time of day and the use start time of day, an estimated non-connection interval of the storage battery 21A from the present time of day to the use start time of day, and a charge output in the storage battery specification information. For example, when the present time of day is 14:30 on 2022/01/07, the charge output is 4.0 kWh, and there is no non-connection interval until the use start time of day, a maximum chargeable amount until the use start time of day is 2.0 kWh. When the maximum chargeable amount until the use start time of day is smaller than a charging amount necessary until the use start time of day calculated earlier, the maximum chargeable amount until the use start time of day can also be outputted as a required charging amount.

In step S73, the required charging amount calculated by the required charging amount calculator 110 is associated with the use start time of day and stored in the required charging amount information DB 113 as required charging amount information.

According to the method described above, a charging amount necessary for a mobile object including a storage battery until a use start time of day can be calculated based on estimated non-connection interval information and estimated battery remaining charge amount information of a single consumer.

### (Application)

The charge/discharge control device 18 may read required charging amount information stored in the required charging amount information DB 113, generate a plan for charging the storage battery 21A up to a charge amount necessary until the use start time of day, and perform charge control of the storage battery 21A according to the plan. When forming the plan, a time slot during which the mobile object is connected may be comprehended using non-connection interval prediction information. In doing so, based on power price information which associates power unit prices and times of day with each other, the charge/discharge control device 18 may specify a time slot during which a charge fee is lowest or a time slot during which an average power unit price is lowest or drops to or below a predetermined value and perform charge during the specified time slot. A time slot may be one continuous time period or may be divided into a plurality of time periods.

### (Hardware Configuration)

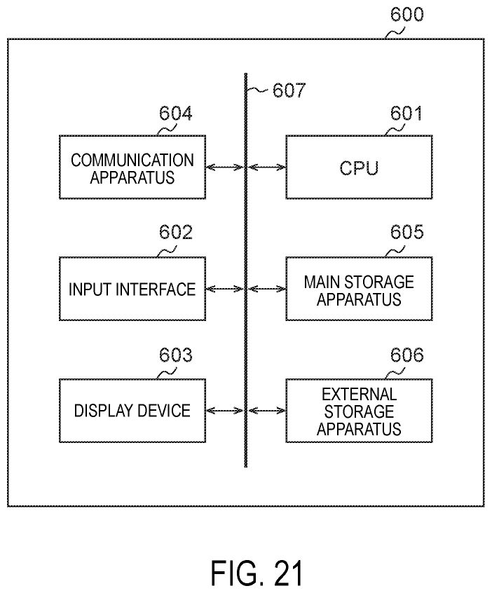

FIG. 21 illustrates a hardware configuration of the information processing device according to each embodiment. The information processing device is configured as a computer device 600. The computer device 600 includes a CPU 601, an input interface 602, a display device 603, a communication device 604, a main storage device 605, and an external storage device 606, and these components are mutually connected through a bus 607.

The CPU (central processing unit) 601 executes an information processing program as a computer program on the main storage device 605. The information processing program is a computer program configured to achieve each above-described functional composition of the present device. The information processing program may be achieved by a combination of a plurality of computer programs and scripts instead of one computer program. Each functional composition is achieved as the CPU 601 executes the information processing program.

The input interface 602 is a circuit for inputting, to the present device, an operation signal from an input device such as a keyboard, a mouse, or a touch panel. The input interface 602 corresponds to the input device in each embodiment.

The display device 603 displays data output from the present device. The display device 603 is, for example, a liquid crystal display (LCD), an organic electroluminescence display, a cathode-ray tube (CRT), or a plasma display (PDP) but is not limited thereto. Data output from the computer device 600 can be displayed on the display device 603. The display device 603 corresponds to the output device in each embodiment.

The communication device 604 is a circuit for the present device to communicate with an external device in a wireless or wired manner. Data can be input from the external device through the communication device 604. The data input from the external device can be stored in the main storage device 605 or the external storage device 606.

The main storage device 605 stores, for example, the information processing program, data necessary for execution of the information processing program, and data generated through execution of the information processing program. The information processing program is loaded and executed on the main storage device 605. The main storage device 605 is, for example, a RAM, a DRAM, or an SRAM but is not limited thereto. Each storage or database in the information processing device in each embodiment may be implemented on the main storage device 605.

The external storage device 606 stores, for example, the information processing program, data necessary for execution of the information processing program, and data generated through execution of the information processing program. The information processing program and the data are read onto the main storage device 605 at execution of the information processing program. The external storage device 606 is, for example, a hard disk, an optical disk, a flash memory, or a magnetic tape but is not limited thereto. Each storage or database in the information processing device in each embodiment may be implemented on the external storage device 606.

The information processing program may be installed on the computer device 600 in advance or may be stored in a storage medium such as a CD-ROM. Moreover, the information processing program in each embodiment may be uploaded on the Internet.

The present device may be configured as a single computer device 600 or may be configured as a system including a plurality of mutually connected computer devices 600.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The embodiments as described before may be configured as below.

### CLAUSES

Clause 1. An information processing apparatus, comprising:
a processing circuitry configured to
   acquire information of a first connection time period during which a mobile object is connected to a charge connector among a first period, the charge connector configured to become capable of control of charge and discharge and measurement of a remaining charge amount of a storage battery included in the mobile object when the mobile object is connected to the charge connector, and information on a remaining charge amount of the storage battery measured during the first connection time period, and
   estimate a second connection time period during which the mobile object is connected to the charge connector among the second period and a remaining charge amount of the storage battery during the second connection time period, based on the information of the first connection time period and the information on the remaining charge amount of the storage battery.

Clause 2. The information processing apparatus according to clause 1, wherein
the processing circuitry is configured to estimate the second connection time period and a remaining charge amount of the storage battery based on information on a first non-connection time period during which the mobile object is not connected to the charge connector.

Clause 3. The information processing apparatus according to clause 2, wherein
the processing circuitry is configured to estimate a second non-connection time period during which the mobile object is not connected to the charge connector in the second period.

Clause 4. The information processing apparatus according to any one of clauses 1 to 3, wherein
the information on the battery remaining charge amount includes the battery remaining charge amount and a measurement time of day of the battery remaining charge amount, and
the processing circuitry is configured to estimate the battery remaining charge amount in the second connection time period for each time of day.

Clause 5. The information processing apparatus according to any one of clauses 1 to 4, wherein
the second period is a period that is temporally posterior to the first period.

Clause 6. The information processing apparatus according to clause 2 or 3, further comprising
a battery remaining charge amount measurer configured to acquire, by measuring the battery remaining charge amount of the mobile object connected to the charge connector during the first period, information on the battery remaining charge amount and information on the first non-connection time period.

Clause 7. The information processing apparatus according to clause 3, wherein
the first non-connection time period includes a non-connection time period for each of a plurality of factors of the mobile object not being connected to the charge connector, and
the processing circuitry is configured to specify a non-connection time period for each factor of the mobile object not being connected to the charge connector based on determination conditions of the plurality of factors of the mobile object and to estimate the second non-connection time period for each factor based on the information on the specified non-connection time period for each factor and information on the battery remaining charge amount.

Clause 8. The information processing apparatus according to clause 7, wherein
among the plurality of factors, a first factor is the mobile object being present at a first location where the mobile object cannot be connected to the charge connector and the mobile object not being connected to the charge connector and a second factor is the mobile object being present at a second location where the mobile object can be connected to the charge connector and the mobile object not being connected to the charge connector.

Clause 9. The information processing apparatus according to clause 8, wherein
the determination conditions include a condition of a time period during which the mobile object is present at the first location, and
the processing circuitry is configured to determine that the mobile object is present at the first location at a time of day satisfying the condition of the time period and determine that the mobile object is present at the second location at a time of day not satisfying the condition of the time period.

Clause 10. The information processing apparatus according to clause 8 or 9, wherein
the determination conditions are conditions based on operating states of one or more devices present at the second location, and
the processing circuitry is configured to specify the non-connection time period for each factor based on information on the operating states of the devices.

Clause 11. The information processing apparatus according to any one of clauses 3, 7 to 10, wherein
the processing circuitry is configured to
specify an attribute of a date represented by the second period and an attribute of one or more dates included in the first period,
detect a date having an attribute that matches the attribute of the second period from the one or more dates included in the first period, and
determine the second non-connection time period in the second period based on information on the first non-connection time period on the detected date.

Clause 12. The information processing apparatus according to clause 11, wherein
the processing circuitry is configured to specify, when there are a plurality of the detected dates, the first non-connection time period of which a frequency of a set of a start time of day and a duration of the first non-connection time period is highest among the first non-connection time periods on the plurality of dates and to estimate the second non-connection time period in the second period based on the specified first non-connection time period.

Clause 13. The information processing apparatus according to clause 12, wherein
the processing circuitry is configured to count the number of times of the first non-connection time period for each of the detected days, and
estimate the second non-connection time period in the second period based on information on the first non-connection time period on the date on which the number of times of the first non-connection time period is a largest number of times.

Clause 14. The information processing apparatus according to clause 13, wherein
as the number of times of the first non-connection time period, a continuous time period during which the mobile object is not connected to the charge connector is assumed to be 1.

Clause 15. The information processing apparatus according to any one of clauses 3, 7 to 14, wherein
the processing circuitry is configured to calculate, based on specification information of the storage battery of the mobile object of a plurality of consumers, demand response-related information regarding a scheduled time of a demand response, and information on the second non-connection time period and information on the battery remaining charge amount having been estimated regarding the second period, a power amount that is chargeable or dischargeable for each of the consumers at the scheduled time of the demand response on the premise that neither charge nor discharge can be executed during the second non-connection time period for each of the consumers, and to calculate a total power amount that is chargeable or dischargeable for all of the consumers by adding up the power amounts for each of the consumers.

Clause 16. The information processing apparatus according to clause 15, wherein
the processing circuitry is configured to transmit information indicating the total power amount at the scheduled time of the demand response to an apparatus of a business operator who manages the demand response or an apparatus for submitting a bid to a power transaction market.

Clause 17. The information processing apparatus according to any one of clauses 3, 7 to 16, wherein
the processing circuitry is configured to calculate, based on a use start time of day of the mobile object and a required charging amount of the storage battery at the use start time of day, specification information of the storage battery, and information on the second non-connection time period and information on the battery remaining charge amount having been estimated regarding the second period, a charge amount of the storage battery necessary until the use start time of day.

Clause 18. The information processing apparatus according to clause 17, wherein
the processing circuitry is configured to determine whether or not power in the charging amount necessary until the use start time of day is chargeable based on information on the second non-connection time period having been estimated regarding the second period.

Clause 19. The information processing apparatus according to clause 18, wherein
the processing circuitry is configured to calculate, when the processing circuitry determines that power in the charging amount necessary until the use start time of day is not chargeable, a power amount that is chargeable until the use start time of day and adopt the calculated power amount as a charging amount that needs to be charged until the use start time of day.

Clause 20. The information processing apparatus according to clause 18 or 19, wherein
the processing circuitry is configured to generate, based on power price information indicating a relationship between times of day and power unit prices and information on the estimated second non-connection time period, a plan to charge the charge amount that needs to be charged until the use start time of day.

Clause 21. The information processing apparatus according to any one of clauses 1 to 19, further comprising
a charge/discharge controller configured to control charge and discharge of the storage battery of the mobile object connected to the charge connector.

Clause 22. An information processing method, comprising:
acquiring information of a first connection time period during which a mobile object is connected to a charge connector among a first period, the charge connector configured to become capable of control of charge and discharge and measurement of a remaining charge amount of a storage battery included in the mobile object when the mobile object is connected to the charge connector, and information on a remaining charge amount of the storage battery measured during the first connection time period; and
estimating a second connection time period during which the mobile object is connected to the charge connector among the second period and a remaining charge amount of the storage battery during the second connection time period, based on the information of the first connection time period and the information on the remaining charge amount of the storage battery.

Clause 23. A non-transitory computer readable medium storing a computer program stored therein which causes a computer to perform processes comprising:
acquiring information of a first connection time period during which a mobile object is connected to a charge connector among a first period, the charge connector configured to become capable of control of charge and discharge and measurement of a remaining charge amount of a storage battery included in the mobile object when the mobile object is connected to the charge connector, and information on a remaining charge amount of the storage battery measured during the first connection time period; and
estimating a second connection time period during which the mobile object is connected to the charge connector among the second period and a remaining charge amount of the storage battery during the second connection time period, based on the information of the first connection time period and the information on the remaining charge amount of the storage battery.

Clause 24. An information processing method, comprising:
a mobile object having a storage battery, in response to being the mobile object connected to a charge connector, which becomes capable of control of charge and discharge and measurement of a remaining charge amount of the storage battery included in the mobile object; and
a processing circuitry configured to
   acquire information of a first connection time period during which the mobile object is connected to a charge connector among a first period, and information on a remaining charge amount of the storage battery measured during the first connection time period; and
   estimate a second connection time period during which the mobile object is connected to the charge connector among the second period and a remaining charge amount of the storage battery during the second connection time period, based on the information of the first connection time period and the information on the remaining charge amount of the storage battery.

1. An information processing apparatus, comprising:
a processing circuitry configured to
acquire information of a first connection time period during which a mobile object is connected to a charge connector among a first period, the charge connector configured to become capable of control of charge and discharge and measurement of a remaining charge amount of a storage battery included in the mobile object when the mobile object is connected to the charge connector, and information on a remaining charge amount of the storage battery measured during the first connection time period, and
estimate a second connection time period during which the mobile object is connected to the charge connector among the second period and a remaining charge amount of the storage battery during the second connection time period, based on the information of the first connection time period and the information on the remaining charge amount of the storage battery.

2. The information processing apparatus according to claim 1, wherein
the processing circuitry is configured to estimate the second connection time period and a remaining charge amount of the storage battery based on information on a first non-connection time period during which the mobile object is not connected to the charge connector.

3. The information processing apparatus according to claim 2, wherein
the processing circuitry is configured to estimate a second non-connection time period during which the mobile object is not connected to the charge connector in the second period.

4. The information processing apparatus according to claim 1, wherein
the information on the battery remaining charge amount includes the battery remaining charge amount and a measurement time of day of the battery remaining charge amount, and
the processing circuitry is configured to estimate the battery remaining charge amount in the second connection time period for each time of day.

5. The information processing apparatus according to claim 1, wherein
the second period is a period that is temporally posterior to the first period.

6. The information processing apparatus according to claim 2, further comprising
a battery remaining charge amount measurer configured to acquire, by measuring the battery remaining charge amount of the mobile object connected to the charge connector during the first period, information on the battery remaining charge amount and information on the first non-connection time period.

7. The information processing apparatus according to claim 3, wherein
the first non-connection time period includes a non-connection time period for each of a plurality of factors of the mobile object not being connected to the charge connector, and
the processing circuitry is configured to specify a non-connection time period for each factor of the mobile object not being connected to the charge connector based on determination conditions of the plurality of factors of the mobile object and to estimate the second non-connection time period for each factor based on the information on the specified non-connection time period for each factor and information on the battery remaining charge amount.

8. The information processing apparatus according to claim 7, wherein
among the plurality of factors, a first factor is the mobile object being present at a first location where the mobile object cannot be connected to the charge connector and the mobile object not being connected to the charge connector and a second factor is the mobile object being present at a second location where the mobile object can be connected to the charge connector and the mobile object not being connected to the charge connector.

9. The information processing apparatus according to claim 8, wherein
the determination conditions include a condition of a time period during which the mobile object is present at the first location, and
the processing circuitry is configured to determine that the mobile object is present at the first location at a time of day satisfying the condition of the time period and determine that the mobile object is present at the second location at a time of day not satisfying the condition of the time period.

10. The information processing apparatus according to claim 8, wherein
the determination conditions are conditions based on operating states of one or more devices present at the second location, and
the processing circuitry is configured to specify the non-connection time period for each factor based on information on the operating states of the devices.

11. The information processing apparatus according to claim 3, wherein
the processing circuitry is configured to
specify an attribute of a date represented by the second period and an attribute of one or more dates included in the first period,
detect a date having an attribute that matches the attribute of the second period from the one or more dates included in the first period, and
determine the second non-connection time period in the second period based on information on the first non-connection time period on the detected date.

12. The information processing apparatus according to claim 11, wherein
the processing circuitry is configured to specify, when there are a plurality of the detected dates, the first non-connection time period of which a frequency of a set of a start time of day and a duration of the first non-connection time period is highest among the first non-connection time periods on the plurality of dates and to estimate the second non-connection time period in the second period based on the specified first non-connection time period.

13. The information processing apparatus according to claim 12, wherein
the processing circuitry is configured to count the number of times of the first non-connection time period for each of the detected days, and
estimate the second non-connection time period in the second period based on information on the first non-connection time period on the date on which the number of times of the first non-connection time period is a largest number of times.

14. The information processing apparatus according to claim 13, wherein
as the number of times of the first non-connection time period, a continuous time period during which the mobile object is not connected to the charge connector is assumed to be 1.

15. The information processing apparatus according to claim 3, wherein
the processing circuitry is configured to calculate, based on specification information of the storage battery of the mobile object of a plurality of consumers, demand response-related information regarding a scheduled time of a demand response, and information on the second non-connection time period and information on the battery remaining charge amount having been estimated regarding the second period, a power amount that is chargeable or dischargeable for each of the consumers at the scheduled time of the demand response on the premise that neither charge nor discharge can be executed during the second non-connection time period for each of the consumers, and to calculate a total power amount that is chargeable or dischargeable for all of the consumers by adding up the power amounts for each of the consumers.

16. The information processing apparatus according to claim 15, wherein
the processing circuitry is configured to transmit information indicating the total power amount at the scheduled time of the demand response to an apparatus of a business operator who manages the demand response or an apparatus for submitting a bid to a power transaction market.

17. The information processing apparatus according to claim 3, wherein
the processing circuitry is configured to calculate, based on a use start time of day of the mobile object and a required charging amount of the storage battery at the use start time of day, specification information of the storage battery, and information on the second non-connection time period and information on the battery remaining charge amount having been estimated regarding the second period, a charge amount of the storage battery necessary until the use start time of day.

18. The information processing apparatus according to claim 17, wherein
the processing circuitry is configured to determine whether or not power in the charging amount necessary until the use start time of day is chargeable based on information on the second non-connection time period having been estimated regarding the second period.

19. The information processing apparatus according to claim 18, wherein
the processing circuitry is configured to calculate, when the processing circuitry determines that power in the charging amount necessary until the use start time of day is not chargeable, a power amount that is chargeable until the use start time of day and adopt the calculated power amount as a charging amount that needs to be charged until the use start time of day.

20. The information processing apparatus according to claim 18, wherein
the processing circuitry is configured to generate, based on power price information indicating a relationship between times of day and power unit prices and information on the estimated second non-connection time period, a plan to charge the charge amount that needs to be charged until the use start time of day.

21. The information processing apparatus according to claim 1, further comprising
a charge/discharge controller configured to control charge and discharge of the storage battery of the mobile object connected to the charge connector.

22. An information processing method, comprising:
acquiring information of a first connection time period during which a mobile object is connected to a charge connector among a first period, the charge connector configured to become capable of control of charge and discharge and measurement of a remaining charge amount of a storage battery included in the mobile object when the mobile object is connected to the charge connector, and information on a remaining charge amount of the storage battery measured during the first connection time period; and
estimating a second connection time period during which the mobile object is connected to the charge connector among the second period and a remaining charge amount of the storage battery during the second connection time period, based on the information of the first connection time period and the information on the remaining charge amount of the storage battery.

23. A non-transitory computer readable medium storing a computer program stored therein which causes a computer to perform processes comprising:
acquiring information of a first connection time period during which a mobile object is connected to a charge connector among a first period, the charge connector configured to become capable of control of charge and discharge and measurement of a remaining charge amount of a storage battery included in the mobile object when the mobile object is connected to the charge connector, and information on a remaining charge amount of the storage battery measured during the first connection time period; and
estimating a second connection time period during which the mobile object is connected to the charge connector among the second period and a remaining charge amount of the storage battery during the second connection time period, based on the information of the first connection time period and the information on the remaining charge amount of the storage battery.

24. An information processing method, comprising:
a mobile object having a storage battery, in response to being the mobile object connected to a charge connector, which becomes capable of control of charge and discharge and measurement of a remaining charge amount of the storage battery included in the mobile object; and
a processing circuitry configured to
acquire information of a first connection time period during which the mobile object is connected to a charge connector among a first period, and information on a remaining charge amount of the storage battery measured during the first connection time period; and
estimate a second connection time period during which the mobile object is connected to the charge connector among the second period and a remaining charge amount of the storage battery during the second connection time period, based on the information of the first connection time period and the information on the remaining charge amount of the storage battery.
